(19) United States
(12) Patent Application Publication
(10) Pub. No.: US 2026/0084556 A1
(43) Pub. Date: Mar. 26, 2026

(54) CHARGER INSTALLATION STRUCTURE FOR VEHICLE

(71) Applicant: TOYOTA JIDOSHA KABUSHIKI KAISHA, Toyota-shi Aichi-ken (JP)

(72) Inventor: Shinya ITO, Toyota-shi Aichi-ken (JP)

(73) Assignee: TOYOTA JIDOSHA KABUSHIKI KAISHA, Toyota-shi Aichi-ken (JP)

(21) Appl. No.: 19/328,337

(22) Filed: Sep. 15, 2025

(30) Foreign Application Priority Data
Sep. 26, 2024 (JP) 2024-167252

(51) Int. Cl. B60L 53/22

(52) U.S. Cl. CPC B60L 53/22; B60L 2210/10

(57) ABSTRACT

A downsized and lightened installation structure of a charger having sufficient rigidity or strength. The installation structure is adapted to fix the charger onto an installation site arranged in a predetermined holding space of a vehicle. The installation structure comprises a bracket connecting the charger to the installation site. The bracket comprises a first fastener joined to the charger, and a second fastener and a third fastener joined to the installation site each, and the third fastener is located at a position deviated from a straight line passing through the first fastener and the second fastener.

### CROSS-REFERENCE TO RELATED APPLICATIONS

The present disclosure claims the benefit of Japanese Patent Application No. 2024-167252 filed on September 26, 2024 with the Japanese Patent Office the entire contents of which are hereby incorporated by reference.

### BACKGROUND

### Technical Field

The embodiment of the present disclosure relates to the art of a charger installation structure for fixing a charger in a vehicle such as an electric vehicle.

### Discussion of the Related Art

One example of a structure for mounting a charger on a vehicle is disclosed in JP-A-2012-76540. The structure described in JP-A-2012-76540 is configured to protect the charger in the event of collision. The charger is arranged in a holding space located on the front section of the vehicle, and a bracket is mounted on a cross member in the holding space. In order to hold a power control unit (PCU), legs are erected on the bracket and the charger is arranged between the legs. On the other hand, the charger is provided with flanges protruding from the left and right sides thereof, and the flanges are fixed to the legs. The charger thus mounted on the vehicles protrudes toward the front section from the PCU. Therefore, when the vehicle collides and a front portion of the vehicle is deformed toward the holding space, the charger is pushed toward the rear section of the vehicle inside the holding space. As a result, the flange is disengaged from the legs by an impact load and the charger is moved rearward in the holding space. For this reason, the load applied to the charger is mitigated to protect the charger.

As described in JP-A-2012-76540, the bracket and flanges are adapted to fix the charger or the power control unit (PCU) to the vehicle body. The load resulting from a collision or the like is applied to the bracket or flanges directly or through the electrical equipment such as the charger. According to the teachings of JP-A-2012-76540, the load applied to the charger is relieved by the breakage of the flanges caused by the impact load.

However, if a space where the electrical device to be protected is allowed to move is insufficient, the load resulting from the collision or the like must be received certainly by the bracket. For this purpose, it is necessary to increase the rigidity of the electrical device and the bracket for fixing the electric device. The rigidity of the bracket may be increased by increasing a size and a thickness of the bracket. However, in order to install the bracket which is a separate member from the electric device and a support member thereof, a fastener such as a bolt is required. The electric device may be held securely by increasing the size of the bracket including the fastener. However, a weight and a cost of the vehicle will be increased.

### SUMMARY

The embodiment of the present disclosure has been conceived noting the foregoing technical problems, and it is therefore an object of the present disclosure to provide a downsized and lightened installation structure of a charger having sufficient rigidity and strength.

According to the exemplary embodiment of the present disclosure, there is provided a charger installation structure for a vehicle that attach a charger to an installation site arranged in a predetermined holding space of the vehicle. In order to achieve the above-explained objective, the charger installation structure is provided with a bracket that connects the charger to the installation site. The bracket comprises a first fastener joined to the charger, and a second fastener and a third fastener joined to the installation site each. The third fastener is located at a position deviated from a straight line passing through the first fastener and the second fastener.

In a non-limiting embodiment, the bracket may comprise a first flat section that is joined to the charger, a second flat section that extends at different level from the first flat section in the vertical direction to be joined to the installation site, and an inclined connecting section formed between the first flat section and the second flat section. The first fastener may be arranged in the first flat section, and the second fastener and the third fastener may be arranged in the second flat section.

In a non-limiting embodiment, the bracket maybe inclined such that the second fastener and the third fastener are situated lower than the first fastener.

In a non-limiting embodiment, the bracket may further comprise: a first extended portion extending from the third fastener along a line passing through the first fastener and the third fastener being in contact with an upper surface of the installation site; and a second extended portion extending from the second fastener along a line passing through the first fastener and the second fastener being in contact with the upper surface of the installation site.

In a non-limiting embodiment, each of the first fastener, the second fastener, and the third fastener may include a bolt penetrating through the bracket to fix the bracket.

In a non-limiting embodiment, the charger may include a main body and a holding frame erected along an outline of the main body, and the bracket may be joined to the holding frame through the first fastener.

In a non-limiting embodiment, the installation site may include an upper surface of a predetermined electric device fixed in the holding space.

In a non-limiting embodiment, the holding space may be formed in a front section of the vehicle, and the charger may partially protrude from the electric device toward a rear section of the vehicle. The first fastener may be positioned in the bracket at the rear of the second fastener and the third fastener in the longitudinal direction of the vehicle. In addition, the second fastener and the third fastener may be joined to a rear section of the electric device, and the first fastener may be joined to the charger.

Thus, according to the exemplary embodiment of the present disclosure, the bracket is joined to the installation site at two portions through the second fastener and the third fastener. Therefore, when the charger is pushed by the load, the load applied to the charger is divided into a load acting in the direction along the straight line connecting the first fastener and the second fastener to be applied to the second fastener, and a load acting in the direction along the straight line connecting the first fastener and the third fastener to be applied to the third fastener. That is, the load applied to the bracket is split, and hence the maximum stress acting on each portion of the charger may be reduced. For this reason, the rigidity or strength required for the bracket may be reduced, and the bracket including fasteners may be downsized and lightened entirely.

According to the exemplary embodiment of the present disclosure, in the bracket, the first flat section and the second flat section are connected through the inclined connecting section. Therefore, when a load is applied to the bracket in the direction to push the first fastener toward the second and the third fastener, the bracket may be lifted by such load. In this situation, the load acting in the direction to lift the bracket is received by two portions of the bracket such as the second fastener and the third fastener. Therefore, the load applied to each of the fasteners or the stress acting on each of the fasteners may be reduced. For this reason, the rigidity or the strength of each of the fasteners may be reduced.

As described, the second fastener and the third fastener are situated lower than the first fastener, and the second fastener and the third fastener may be lifted by the above-mentioned load. Nonetheless, the load applied to the bracket is split into two directions toward the second and the third fastener as explained above. According to the exemplary embodiment of the present disclosure, therefore, the rigidity or the strength of each of the fasteners may be reduced.

As also described, the bracket is joined to the installation site by the bolts of the second fastener and the third fastener. According to the exemplary embodiment of the present disclosure, therefore, the bracket may be fixed effectively by the two bolts without increasing a size of each bolt.

According to the exemplary embodiment of the present disclosure, the bracket is joined to the upper surface of the predetermined electrical device through the second fastener and the third fastener, and the charger is supported by the bracket. According to the exemplary embodiment of the present disclosure, therefore, the charger and the predetermined electric device may be superposed in the vertical direction to be held in the holding space.

The rear end portion of the charger laid on the electric device protrudes from the electric device toward the rear section of the vehicle. Therefore, when the electric device and the charger are pushed toward the rear section of the vehicle by a load applied to the front section of the vehicle, the rear end portion of the charger comes into contact with other components before the electric device. In this situation, a load directed toward the front section is applied to the bracket, but the load is split into two directions toward the second and the third fastener. According to the exemplary embodiment of the present disclosure, therefore, the maximum rigidity or the maximum strength required for the bracket may be reduced, and the bracket including fasteners may be downsized and lightened entirely.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing a mounting position and a posture of the charger according to the exemplary embodiment of the present disclosure;

FIG. 2 is a perspective view showing the PCU upper cover, the bracket for mounting the charger, and the intermediate bracket;

FIG. 3 is a side view of the charger mounted on the PCU upper cover;

FIG. 4 is a plan view of the intermediate bracket;

FIG. 5 is a side view of the intermediate bracket; and

FIG. 6A is a diagram showing a measurement result of a tensile load applied to the bolt of the second fastener; and

FIG. 6B is a diagram showing a measurement result of a tensile load applied to the bolt of the third fastener.

### DETAILED DESCRIPTION OF THE EMBODIMENT(S)

An exemplary embodiment of the present disclosure will now be explained with reference to the accompanying drawings. It should be noted that the embodiment described below is merely an example of the present disclosure which should not limit a scope of the present disclosure.

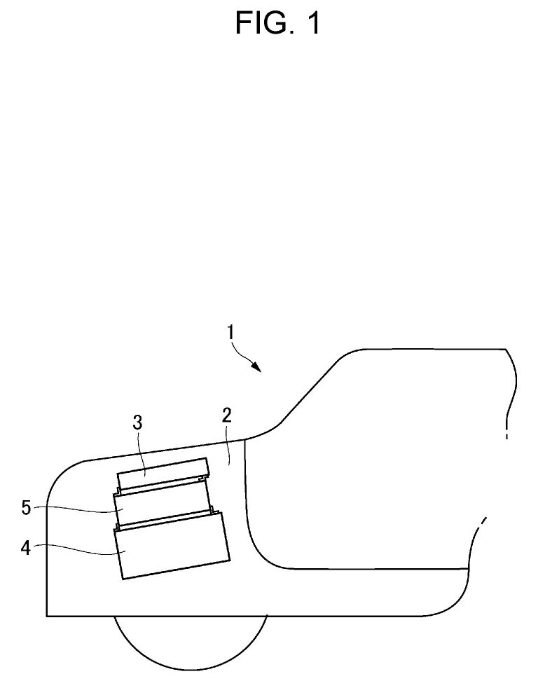

The present disclosure relates to a structure for installing a charger in a vehicle. Turning now to FIG. 1, there is schematically shown one example of the installation structure. In the vehicle 1, a holding space 2 is formed in a front section of the vehicle 1. The holding space 2 corresponds to an engine compartment of conventional engine vehicles. A charger 3 is superposed on electric devices such as a DCDC converter 4 and a power control unit (PCU) 5. According to the example shown in FIG. 1, the charger 3 is mounted on the PCU 5. The electric devices and the charger 3 thus stacked are inclined such that the front side in the longitudinal direction of the vehicle 1 is lowered in accordance with a configuration of the holding space 2. Accordingly, the PCU 5 or the upper cover thereof serves as an installation site of the exemplary embodiment of present disclosure.

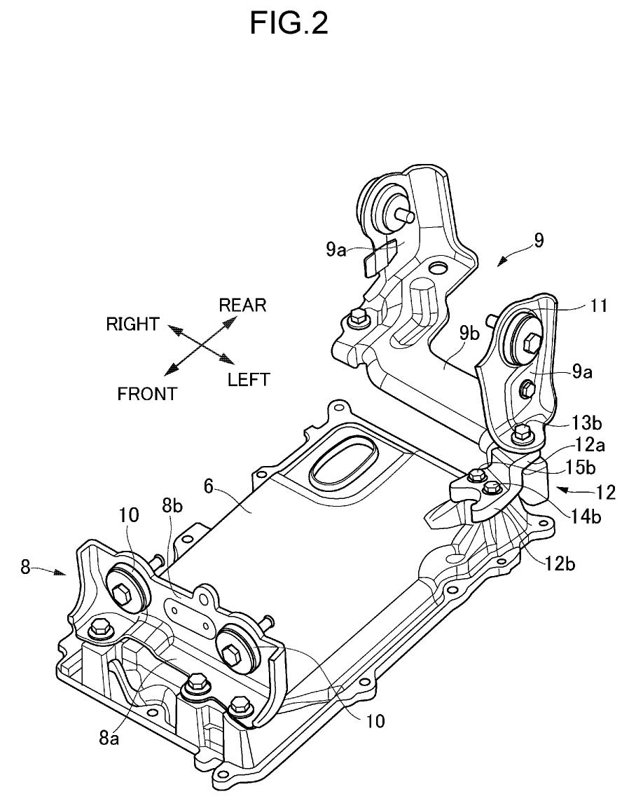

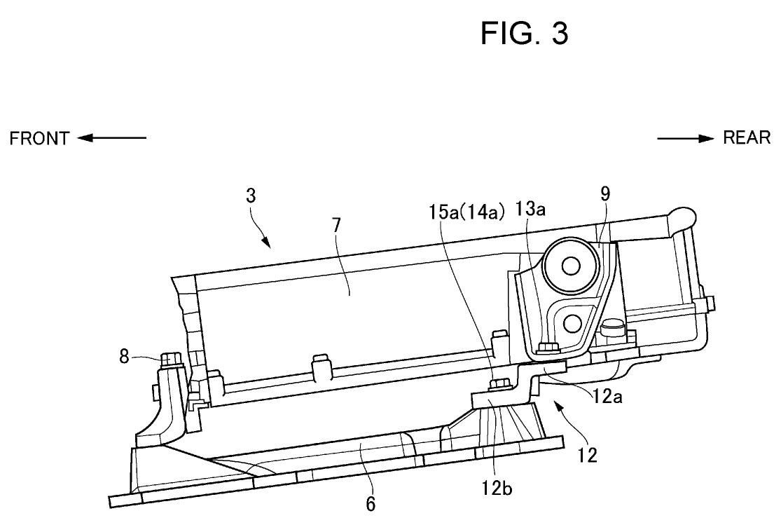

A structure for fixing the charger 3 to the PCU upper cover (hereinafter, simply referred to as the upper cover) 6 is shown in FIGS. 2 and 3. The upper cover 6 has a substantially rectangular shape, and is arranged such that the left front side in FIG. 2 is oriented to the front section of the vehicle 1. The charger 3 also has a substantially rectangular shape that is slightly longer than the upper cover 6, and a width thereof is substantially identical to a width of the upper cover 6. As illustrated in FIG. 3, the charger 3 includes a main body 7 and a pair of brackets 8 and 9 attached to the front end and the rear section of the main body 7. The main body 7 is attached to the upper cover 6 through the brackets 8 and 9. Accordingly, the brackets 8 and 9 serve as a holding frame of the exemplary embodiment of the present disclosure.

The bracket 8 comprises a bottom plate section 8a fixed to an upper surface of the upper cover 6, and a wall section 8b erected on the bottom plate section 8a to be opposed to the front side of the main body 7. Specifically, the bracket 8 is joined to the main body 7 through a bush 10 penetrating through the wall section 8b. The bracket 9 comprises a pair of side wall sections 9a opposed to left and right sides of the main body 7 in the rear end section, and a bottom plate section 9b connecting lower end portions of the side wall sections 9a. Specifically, the bracket 9 is joined to the main body 7 through a bush 11 penetrating through the side wall section 9a.

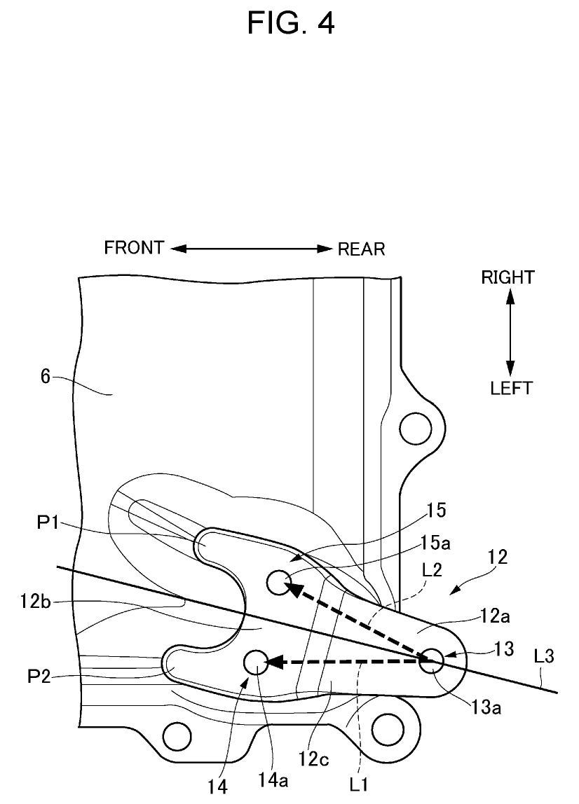

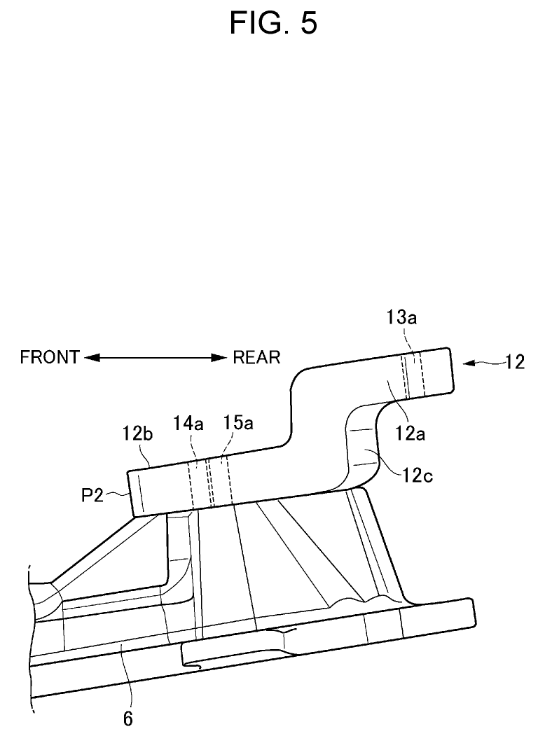

A rear end portion of the charger 3 is joined to the upper cover 6 through an intermediate bracket 12 serving as a bracket of the exemplary embodiment of the present disclosure. The intermediate bracket 12 is illustrated in FIGS. 4 and 5 in more detail. The intermediate bracket 12 is made of metal such as steel, and intermediate bracket 12 comprises a first flat section 12a that is joined tightly to the lower surface of the bracket 9 holding the charger 3, a second flat section 12b that is joined tightly to an upper surface of the upper cover 6, and a connecting section 12c that connects the flat sections 12a and 12b. As illustrated in FIG. 5, the first flat section 12a and the second flat section 12b extend at different levels in the vertical direction or the plate thickness direction. Therefore, the connecting section 12c is inclined as shown in FIG. 5. Accordingly, the connecting section 12c serves as the inclined connecting section of the exemplary embodiment of the present disclosure. In addition, the intermediate bracket 12 is gradually widened from the first flat section 12a toward the second flat section 12b. Therefore, the intermediate bracket 12 has a substantially triangular shape in a planer view.

A first fastener 13 is arranged on a predetermined site in the first flat section 12a. For example, the first fastener 13 includes a bolt hole 13a penetrating through the first flat section 12a in the thickness direction, and a bolt 13b inserted into the bolt hole 13a. In addition, other fasteners are arranged on two sites in the second flat section 12b whose width is wider. Specifically, a second fastener 14 and a third fastener 15 are arranged on the second flat section 12b. Likewise, the second fastener 14 includes a bolt hole 14a penetrating through the second flat section 12b in the thickness direction and a bolt 14b inserted into the bolt hole 14a, and the third fastener 15 includes a bolt hole 15a penetrating through the second flat section 12b in the thickness direction and a bolt 15b inserted into the bolt hole 15a.

As illustrated in FIG. 4, the first fastener 13, the second fastener 14, and the third fastener 15 are located at positions corresponding to corners of a triangle. In other words, one of the fasteners is located at a position deviated from a straight line passing through another two of the fasteners. In the example shown in FIG. 4, the first fastener 13 and the second fastener 14 are arranged along the long side of the upper cover 6 extending in the longitudinal direction of the vehicle 1. Whereas, the third fastener 15 is arranged at a position closer to the center of the upper cover 6 in the width direction corresponding to the vertical direction in FIG. 4. Accordingly, the straight line passing through the first fastener 13 and the third fastener 15 extends diagonally forward right in the vehicle 1.

The intermediate bracket 12 is disposed at a left corner on the rear end side of the upper cover 6 in the longitudinal direction of the vehicle 1. The bolt 14b inserted into the bolt hole 14a of the second fastener 14 and the bolt 15b inserted into the bolt hole 15a of the third fastener 15 are screwed into the upper cover 6 so that the intermediate bracket 12 is joined and fixed to the upper cover 6. Further, the first flat section 12a is laid tightly on the bottom plate section 9b of the bracket 9 of the charger 3, and the bolt 13b inserted into the bolt hole 13a of the first fastener 13 is screwed into the charger 3 or the bracket 9 so that the intermediate bracket 12 is joined and fixed to the charger 3. Thus, the rear end portion of the charger 3 is joined and fixed to the upper cover 6 through the intermediate bracket 12.

FIG. 3 shows the charger 3 mounted on the upper surface of the upper cover 6. As described above, the charger 3 has a rectangular shape or a rectangular parallelepiped shape that is slightly longer than the upper cover 6. Therefore, as shown in FIG. 3, the rear end portion of the charger 3 protrudes from the upper cover 6 toward the rear section. Although not especially shown in the drawings, a large number of other components required for the vehicle 1 are arranged in the holding space 2, and some of those components are arranged close to the rear end portion of the charger 3. Therefore, when the DCDC converter 4 and the PCU 5 are moved toward the rear section of the vehicle 1 by a load resulting from a collision applied to the front section of the vehicle 1, the rear end portion of the charger 3 comes into contact with other components arranged close to the rear end portion. As a result, the charger 3 is pushed back by other components toward the front section of the vehicle 1. Thus, the intermediate bracket 12 receives the load directed toward the front section of the vehicle.

The load acting on the intermediate bracket 12 in a situation where the charger 3 is retracted and the charger 3 is pushed back toward the front section by other components in the event of a collision of the vehicle 1 will be discussed hereinafter. When the collision load is applied to the vehicle 1 from the right front side in FIG. 4, the load acts on the intermediate bracket 12 along the line L3 extending between the line L1 connecting the first fastener 13 and the second fastener 14 and the line L2 connecting the first fastener 13 and the third fastener 15. As described above, the charger 3 is inclined such that the front section in the vehicle 1 is lowered. In addition, in the intermediate bracket 12, the first fastener 13 is positioned higher than the second fastener 14 and the third fastener 15 to be close to the charger 3 as illustrated in FIGS. 3 and 5. Whereas, the load applied from the right front section of the vehicle 1 and the stress derived therefrom act substantially horizontally.

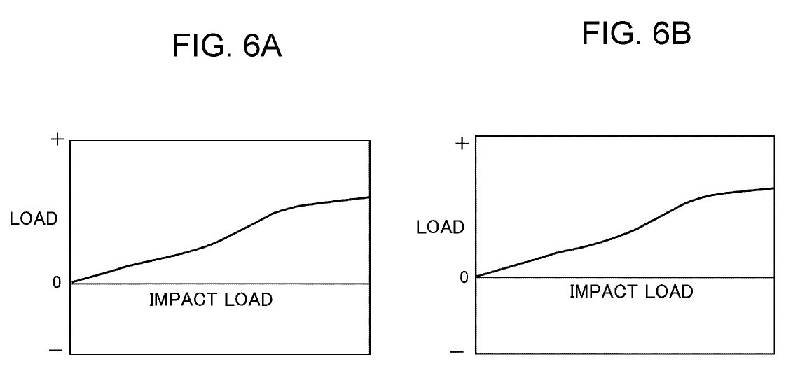

Therefore, the intermediate bracket 12 serves as a lever in which a first extended portion P1 extending from the third fastener 15 and a second extended portion P2 extending from the second fastener 14 serve as fulcrums supported by the upper cover 6 from below, the first fastener 13 serves as an effort, and the second fastener 14 and the third fastener 15 serve as loads. Consequently, the bolt 14b of the second fastener 14 and the bolt 15b of the third fastener 15 are individually subjected to a tensile load acting in the axial direction. The magnitude of the tensile load is governed by a ratio between: a distance from the first fastener 13 to a leading end of the second extended portion P2 of the intermediate bracket 12 along the line L1 passing through the first fastener 13 and the second fastener 14, and a distance from the second fastener 14 to the leading end of the second extended portion P2; and a ratio between a distance from the first fastener 13 to a leading end of the first extended portion P1 of the intermediate bracket 12 along the line L2 passing through the first fastener 13 and the third fastener 15, and a distance from the third fastener 15 to the leading end of the first extended portion P1.

[0041 ] As shown in FIG. 4, in the intermediate bracket 12, the dimensions and the ratios of the portions on the second fastener 14 side and the portions on the third fastener 15 side are substantially identical to each other. Therefore, the load applied to the bolt 14b of the second fastener 14 and the load applied to the bolt 15b of the third fastener 15 are substantially equal to each other. The magnitude of the load applied to the bolt 14b of the second fastener is shown in FIG. 6A, and the magnitude of the load applied to the bolt 15b of the third fastener is shown in FIG. 6B. In FIGS. 6A and 6B, each horizontal axis represents an impact load resulting from a collision or the like, and each vertical axis represents a load applied to the bolt 14b or 15b. Since the intermediate bracket 12 tends to move along the upper surface of the upper cover 6, the bolt 14b of the second fastener 14 and the bolt 15b of the third fastener 15 are individually subjected to a shearing force. In the example shown in FIG. 4, since the relative positions of the second fastener 14 and the third fastener 15 with respect to the first fastener 13 are approximate to each other, the shearing forces acting on the bolts 14b and 15b are substantially equal to each other.

Thus, according to the exemplary embodiment of present disclosure, the tensile load and the shearing load are applied substantially equally to the second fastener 14 and the third fastener 15 receiving the load on the upper cover 6 side. That is, each of the second fastener 14 and the third fastener 15 exert the fastening function effectively. In other words, it is not necessary to enhance the rigidities or strengths of the second fastener 14 and the third fastener 15. For this reason, according to the exemplary embodiment of the present disclosure, a size of the installation structure will not be enlarged and a weight of the installation structure will not be increased by partially enhancing the rigidity or strength thereof.

Note that present disclosure should not be limited to the foregoing embodiment, and may be modified arbitrarily to be implemented. For example, the charger may also be arranged horizontally. In addition, the bracket may be formed entirely into a flat plate shape without having the above-described inclined connecting section. Further, the contour of the bracket is not limited to the triangular shape, and it may be altered arbitrarily as necessary. The holding space may also be arranged in the rear section of the vehicle instead of the front section. Furthermore, the bracket according to present disclosure should not be limited to the intermediate bracket described in the embodiment, and it may be configured to connect the installation site such as the upper cover and the charger at a plurality of sites. In addition, the bracket may also be arranged on the front section of the charger instead of the rear section in the longitudinal direction of the vehicle.

WHAT IS CLAIMED IS:

1. A charger installation structure for a vehicle that attach a charger to an installation site arranged in a predetermined holding space of the vehicle, comprising:
a bracket that connects the charger to the installation site,
wherein the bracket comprises a first fastener joined to the charger, and a second fastener and a third fastener joined to the installation site each, and
the third fastener is located at a position deviated from a straight line passing through the first fastener and the second fastener.

2. The charger installation structure for the vehicle as claimed in claim 1,
wherein the bracket comprises a first flat section that is joined to the charger, a second flat section that extends at different level from the first flat section in a vertical direction to be joined to the installation site, and an inclined connecting section formed between the first flat section and the second flat section,
the first fastener is arranged in the first flat section, and
the second fastener and the third fastener are arranged in the second flat section.

3. The charger installation structure for the vehicle as claimed in claim 1, wherein the bracket is inclined such that the second fastener and the third fastener are situated lower than the first fastener.

4. The charger installation structure for the vehicle as claimed in claim 3, wherein the bracket further comprises:
a first extended portion extending from the third fastener along a line passing through the first fastener and the third fastener being in contact with an upper surface of the installation site; and
a second extended portion extending from the second fastener along a line passing through the first fastener and the second fastener being in contact with the upper surface of the installation site.

5. The charger installation structure for the vehicle as claimed in claim 3, wherein each of the first fastener, the second fastener, and the third fastener includes a bolt penetrating through the bracket to fix the bracket.

6. The charger installation structure for the vehicle as claimed in claim 3,
wherein the charger includes a main body and a holding frame erected along an outline of the main body, and
the bracket is joined to the holding frame through the first fastener.

7. The charger installation structure for the vehicle as claimed in claim 6, wherein the installation site includes an upper surface of a predetermined electric device fixed in the holding space.

8. The charger installation structure for the vehicle as claimed in claim 7,
wherein the holding space is formed in a front section of the vehicle,
the charger partially protrudes from the electric device toward a rear section of the vehicle, and
the first fastener is positioned in the bracket at the rear of the second fastener and the third fastener in a longitudinal direction of the vehicle,
the second fastener and the third fastener are joined to a rear section of the electric device, and
the first fastener is joined to the charger.

9. The charger installation structure for the vehicle as claimed in claim 2, wherein the bracket is inclined such that the second fastener and the third fastener are situated lower than the first fastener.

10. The charger installation structure for the vehicle as claimed in claim 9, wherein the bracket further comprises:
a first extended portion extending from the third fastener along a line passing through the first fastener and the third fastener being in contact with an upper surface of the installation site; and
a second extended portion extending from the second fastener along a line passing through the first fastener and the second fastener being in contact with the upper surface of the installation site.

11. The charger installation structure for the vehicle as claimed in claim 9, wherein each of the first fastener, the second fastener, and the third fastener includes a bolt penetrating through the bracket to fix the bracket.

12. The charger installation structure for the vehicle as claimed in claim 9,
wherein the charger includes a main body and a holding frame erected along an outline of the main body, and
the bracket is joined to the holding frame through the first fastener.

13. The charger installation structure for the vehicle as claimed in claim 12, wherein the installation site includes an upper surface of a predetermined electric device fixed in the holding space.

14. The charger installation structure for the vehicle as claimed in claim 13,
wherein the holding space is formed in a front section of the vehicle,
the charger partially protrudes from the electric device toward a rear section of the vehicle, and
the first fastener is positioned in the bracket at the rear of the second fastener and the third fastener in a longitudinal direction of the vehicle,
the second fastener and the third fastener are joined to a rear section of the electric device, and
the first fastener is joined to the charger.
